(19) United States
(12) Patent Application Publication
(10) Pub. No.: US 2008/0234893 A1
(43) Pub. Date: Sep. 25, 2008

(54) WINDOW CONTROL SYSTEM

(75) Inventors: Bradley J. Mitchell, Snohomish, WA (US); Trevor M. Laib, Woodinville, WA (US); Henry V. Fletcher, Everett, WA (US)

Correspondence Address: TUNG & ASSOCIATES / RANDY W. TUNG, ESQ., 838 W. LONG LAKE ROAD, SUITE 120, BLOOMFIELD HILLS, MI, 48302, US

(73) Assignee: The Boeing Company

(21) Appl. No.: 11/862,395

(22) Filed: Sep. 27, 2007

Related U.S. Application Data
(63) Continuation-in-part of application No. 11/690,316, filed on Mar. 23, 2007.
Application No. 11/690,316 is a continuation-in-part of application No. 11/694,013, filed on Mar. 30, 2007.

(51) Int. Cl. G06F 7/00

(52) U.S. Cl. 701/36

(57) ABSTRACT

Electrically dimmable windows for aircraft are powered by energy harvesting devices on-board the aircraft. The harvested energy is stored and used to control the opacity of the windows based on individual window opacity settings selected either by passengers or a cabin attendant. Each window has an associated control circuit that controls the electrical power applied to the window based on the selected opacity setting. The control circuit includes a low energy usage processor that remains in a sleep mode until a change in the opacity setting is detected. Each control circuit may include a radio transceiver that receives control signals from a transmitter operated by the cabin attendant in order to simultaneously remotely control the opacity settings of multiple windows.

### CROSS REFERENCE TO RELATED APPLICATIONS

This application is a continuation-in-part of U.S. patent application No. 11/690,316 filed Mar. 23, 2007 and application Ser. No. 11/694,013 filed Mar. 30, 2007, the entire disclosures of which are incorporated by reference herein.

### TECHNICAL FIELD

This disclosure generally relates to centralized control of spatially distributed devices, and deals more particularly with a system for wireless control of individual devices such as dimmable windows on-board a vehicle.

### BACKGROUND

Electrically dimmable windows have been purposed for use in aircraft in order to control interior cabin illumination. These windows may be controlled by electrical power applied to special materials in the windows in order to change their opacity.

In some applications, it may be useful to provide central control of the dimmable windows by a pilot or cabin attendant, who may adjust the dimming settings of any or all of the windows for passenger comfort, or for safety reasons. In order to connect the windows with a central dimmer controller, wiring may need to be installed along the length of the aircraft, representing both additional cost and weight. In some retrofit applications, it may not be feasible or cost effective to provide central dimming control because of the required wiring.

Accordingly, there is a need for a central control system for dimming windows in vehicles, such as aircraft, which overcomes the problems discussed above. The present disclosure is intended to satisfy this need.

### SUMMARY

Spatially distributed, electrically operated components, such as electrically dimmable windows for aircraft may be controlled by a central controller using a wireless network. The central controller may include a radio frequency transmitter for sending window control signals to any or all of the dimmable windows. In one embodiment, the wireless transmission range of the central controller may be extended using wireless signal repeaters that form nodes along the length of the aircraft. Each node retransmits window control signals issued by the central controller to a group of windows that are within the transmission range of the node. Each node also retransmits the window control signals to the next node along the length of the aircraft in order to assure that all windows are within transmission range of at least one node.

In another embodiment, transceivers forming part of the individual window controllers are used as repeaters which retransmit window control signals to nearby window controllers within transmission range of the repeater. The window control signals propagate wirelessly from the central controller and between the window controllers so that all windows receive wireless control signals.

Each of the dimmable windows and its associated controller may be powered by one or more energy harvesting devices onboard the aircraft. Harvested energy is stored as electrical power in a storage device which is used to operate the window and its associated controller.

According to one disclosed embodiment, a system is provided for controlling windows onboard an aircraft comprising: a central controller including a wireless transmitter for transmitting window control signals; at least a first wireless repeater onboard the aircraft for receiving and retransmitting the window control signals; and, at least a first group of window controllers respectively associated with and proximal to a first group of the windows for controlling the operation of the associated windows, each of the controllers in the first group including a wireless receiver for receiving the retransmitted window control signals. At least certain of the window controllers may also receive window control signals directly from the central controller. Additional wireless repeaters may be provided for relaying the window control signals to extend the communication range of the central controller.

According to another disclosed embodiment, a system is provided for controlling a plurality of spatially distributed devices onboard an aircraft, comprising: a central controller including a wireless transmitter for transmitting device control signals; and, a plurality of local controllers respectively associated with and proximal to the devices for controlling the operation of the devices. Each of the local controllers includes a wireless receiver for receiving device control signals. At least one of the local controllers includes a wireless transmitter for retransmitting control signals received from the central controller. The system may further comprise at least one wireless repeater onboard the aircraft for receiving and retransmitting the received device control signals.

According to another disclosed embodiment, a method is provided for centralized control of spatially distributed devices located onboard a vehicle. The method comprises the steps of: wirelessly transmitting device control signals from a central control location onboard the vehicle; receiving the transmitted signals at a first node onboard the vehicle; wirelessly retransmitting the device control signals from the first node; and, receiving device control signals at a device location that originate either from the central control location or the first node. The method may further comprise the steps of receiving the retransmitted device control signals at a second node, and wirelessly retransmitting the device control signals from the second node.

According to still another disclosed embodiment, a method is provided for controlling electrically operated windows on an aircraft from a central location onboard the aircraft. The method comprises the steps of: transmitting wireless window control signals from the central location Lo a repeater onboard the aircraft; receiving the window control signals at the repeater; retransmitting the window control signals; receiving the retransmitted window control signals at a first window location; and, controlling a window at the first window location using the retransmitted window control signals. The method may further comprise the steps of receiving the window control signals from the central control location at a second window location, and controlling a window at the second window location using the received window control signals. Controlling the window may include changing the opacity of the window. The method may further include harvesting energy from onboard the aircraft, storing the harvested energy as electrical power, and using the electrical power to control the opacity of the window. The control signals may be encoded with information identifying the intended window destination of each of the window control signals.

Other features, benefits and advantages of the disclosed embodiments will become apparent from the following description of embodiments, when viewed in accordance with the attached drawings and appended claims.

### BRIEF DESCRIPTION OF THE ILLUSTRATIONS

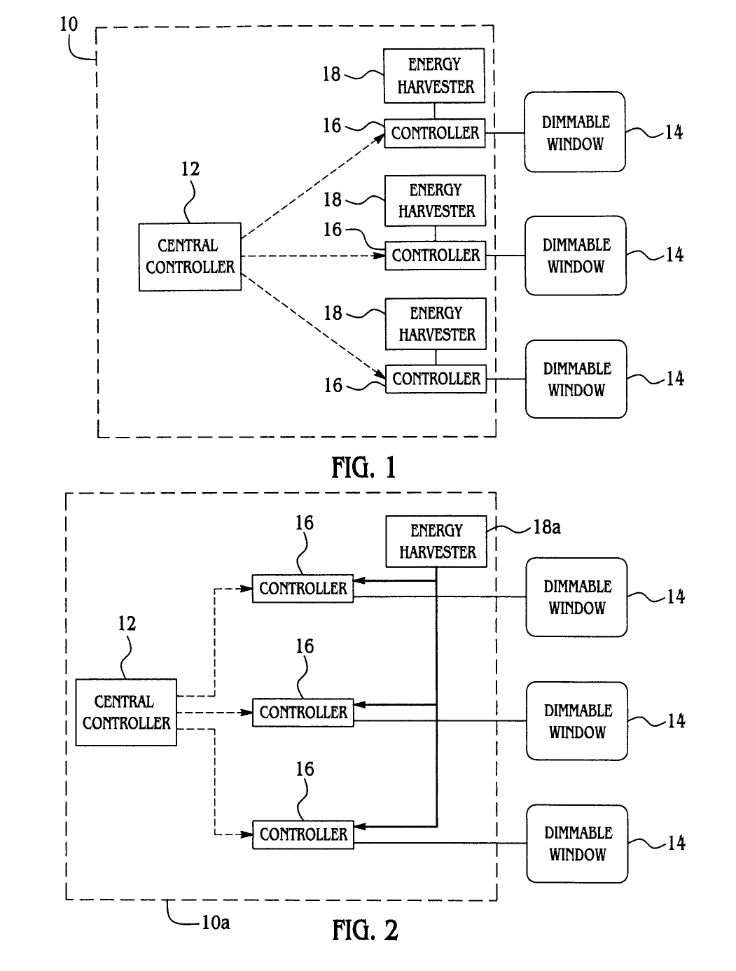

FIG. 1 is a block diagram illustration showing a control system for dimmable windows in accordance with one embodiment.

FIG. 2 is a block diagram illustration of an alternate embodiment of the control system.

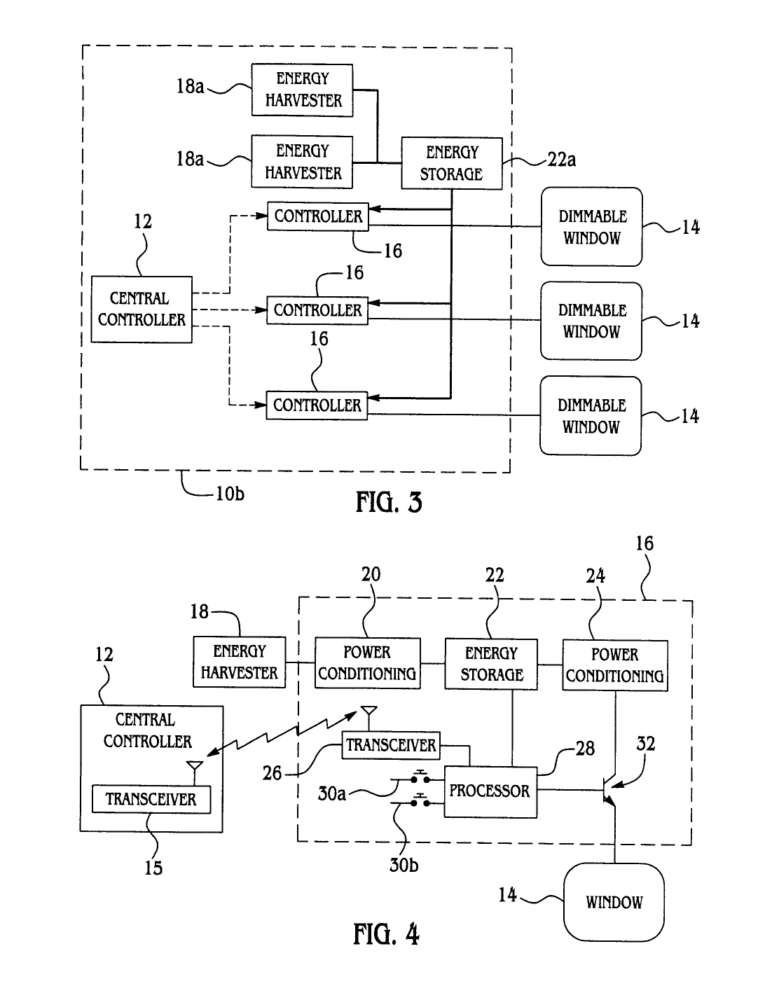

FIG. 3 is a block diagram illustration of another embodiment of the control system.

FIG. 4 is a combined block and schematic illustration showing additional details of a control circuit used in the system shown in FIG. 1.

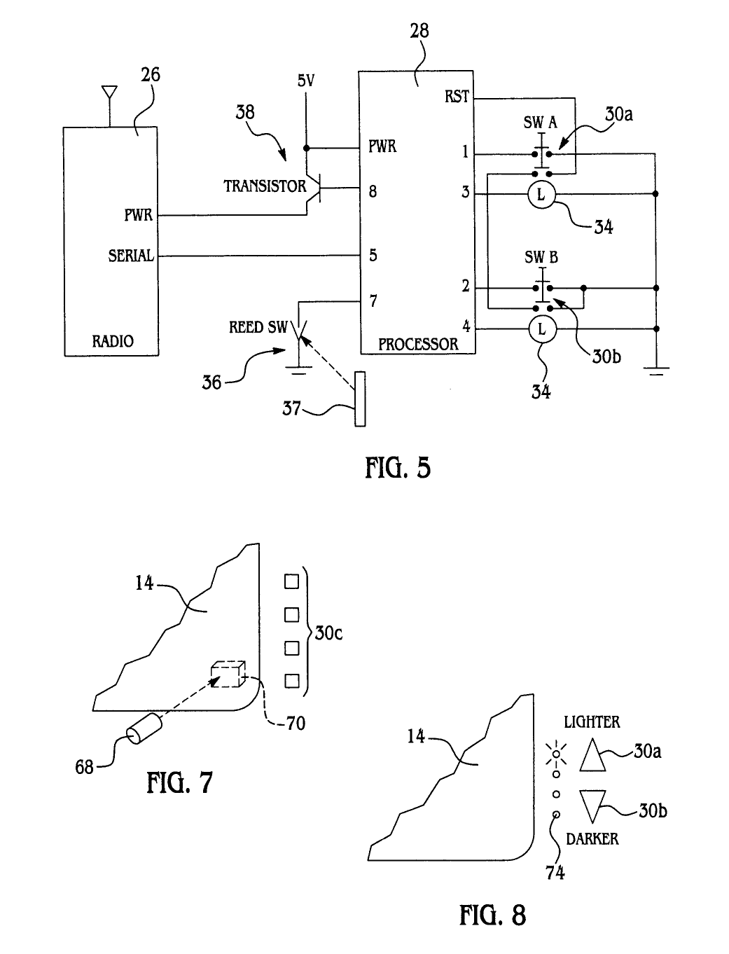

FIG. 5 is a combined block and schematic illustration showing further details of the control circuit shown in FIG. 4.

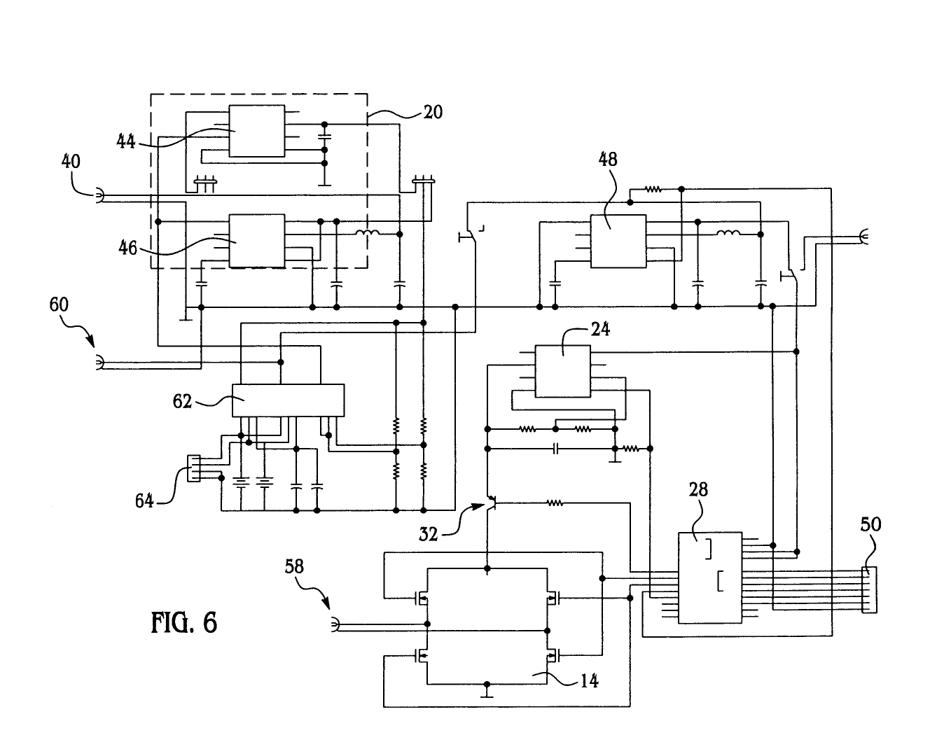

FIG. 6 is a detail schematic illustration of the control circuit.

FIG. 7 is a diagrammatic illustration of a dimmable window with adjustment controls and an opacity sensor.

FIG. 8 is a diagrammatic illustration of a dimmable window having an alternate form of adjustment controls.

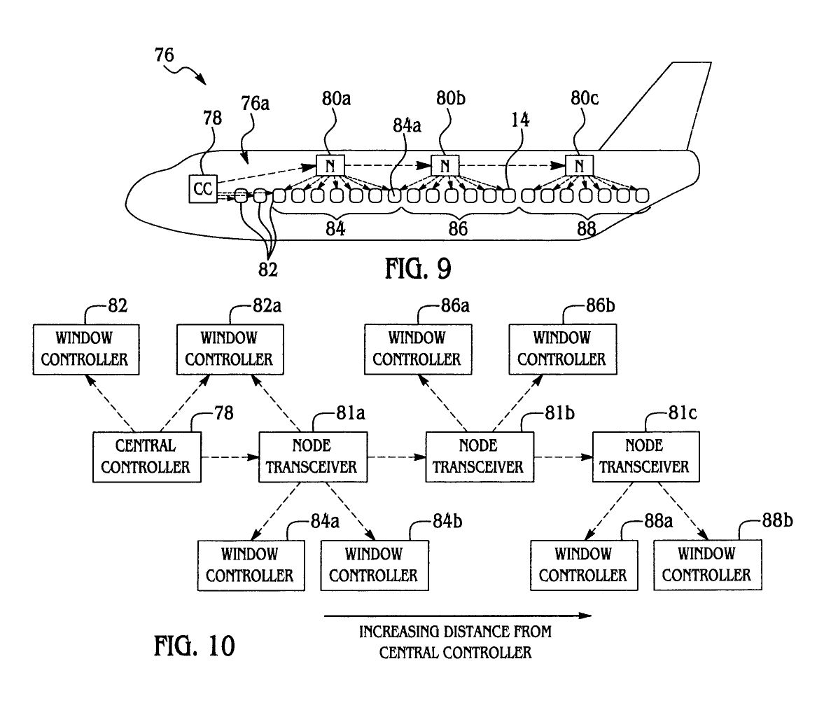

FIG. 9 is a diagrammatic illustration of an embodiment of a wireless window control system using multiple nodes.

FIG. 10 is a block diagram illustration of a wireless network used in the window control system shown in FIG. 9.

FIG. 11 is a combined block and schematic illustration of the components forming the window control system shown in FIGS. 9 and 10.

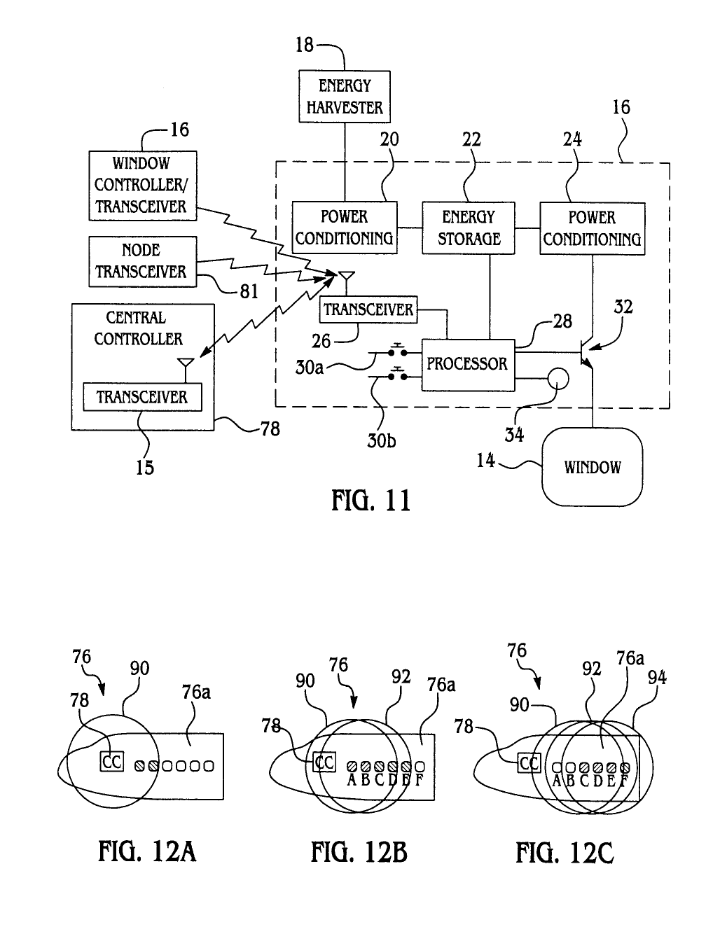

FIGS. 12a, 12b and 12c are diagrammatic views of the forward fuselage section of an aircraft, illustrating a window control system that forms another disclosed embodiment.

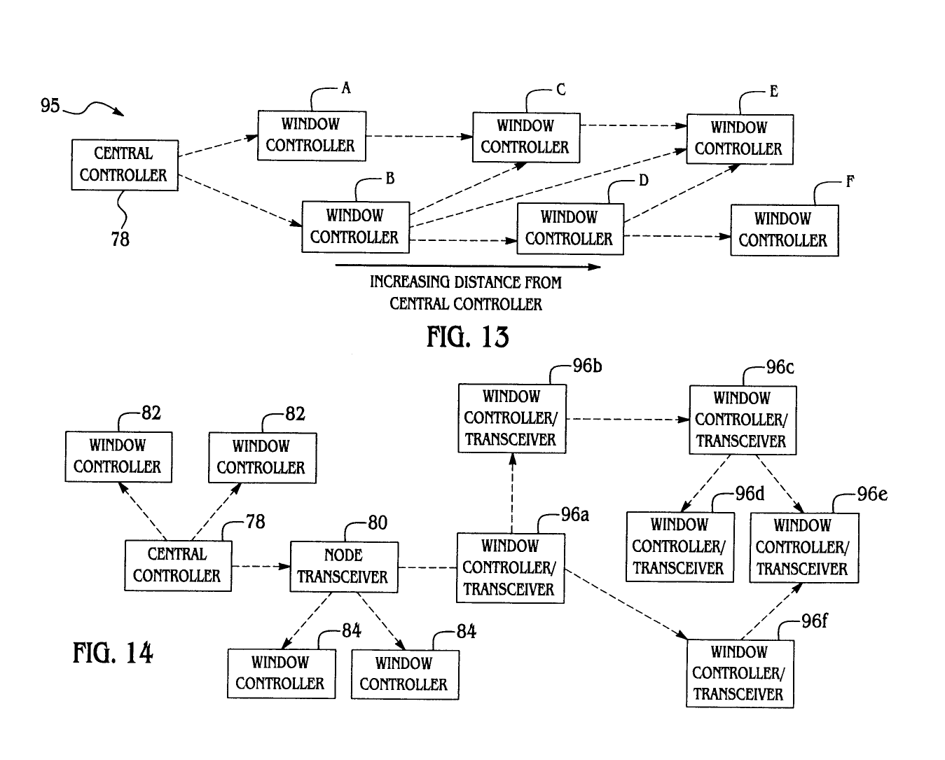

FIG. 13 is a block diagram illustrating a wireless network used in the window control system illustrated in FIGS. 12a-12c.

FIG. 14 is a block diagram of a window control system forming a further embodiment.

### DETAILED DESCRIPTION

Referring first to FIG. 1, a control system 10 is provided for controlling one or more dimmable windows 14 on a vehicle (not shown), such as a commercial aircraft. The dimmable windows 14 are typically located in the fuselage of the aircraft at cabin locations where illumination from natural light is desired, or where a view to the outside may be desired. The dimmable windows 14 may be constructed using any of various technologies previously described, including those using an electrochromatic membrane which changes opacity based on an applied electric charge. The electrical charge, and thus the opacity of the window, may be varied by applying a voltage of positive or negative polarity across the membrane. In one embodiment, the window 14 holds its opacity state when no electric charge is applied to the membrane. Typically, the window 14 increases its opacity when an electrical voltage is applied of one polarity, and decreases its opacity when an electrical voltage is applied of the opposite polarity. In effect, the dimmable window 14 may be thought of as a large capacitor whose electric charge may be varied. In one embodiment, the range of applied voltages may be from −1.2V to +1.2V, where −1.2V yields a transparent window, and +1.2V yields an opaque window.

The voltage applied to each of the dimmable windows 14 is controlled by an associated controller 16 using electrical energy produced by an energy harvesting device 18. The energy harvesting device 18 may comprise, by way of example and without limitation, a thermoelectric energy harvesting device that generates electrical power from a thermal gradient on-board the aircraft. For example, a thermoelectric energy harvesting device may be placed between two solid materials of different temperatures or between a solid and a fluid at different temperatures to generate electricity. In the case of aircraft, such surfaces include the aircraft fuselage structure, the aircraft window frame structure, the window exterior surface, various window inner panes (including the electrochromatic dimming surface itself), the sidewall panel and heat sinks that may be placed in air spaces such as the air between the side wall panel and the insulation blankets or the air spaces between the window inner panes. These thermoelectric devices take advantage of the temperature extremes experienced by the aircraft while cruising at high altitudes, and to a lesser degree during warm days and nights while on the ground. A thermoelectric energy harvesting device of the type described above may be integrated into a stringer clip to generate electricity from the temperature differential across the aircraft insulation blankets.

Other types of energy harvesting devices 18 are contemplated. For example, an energy harvesting device 18 may be employed that converts radiation into electrical power. One example of such a device is a photovoltaic device, also known as a solar cell that converts light energy (photons) into electrical power. Sources of light energy near passenger windows on aircraft include solar radiation and cabin lighting. The energy harvesting device 18 may comprise a device for converting motion into electrical power. For example, piezoelectric or electrodynamic devices may be used to harvest energy, by converting vibration and motion energy into electricity. Vibration/motion energy exists near passenger windows in the form of aircraft skin vibration, wing movement, side wall panel vibration and aircraft turbulence motion. It should be noted here that the energy harvesting device 18 may comprise a combination of any of the energy conversion devices discussed immediately above

As will be discussed in more detail below, the controller 16 is responsive to dimming adjustment controls operated by a passenger at a window 14 for controlling the opacity of the window 14 using electrical power generated by the energy harvester 18. Thus, each of the passengers adjacent one of the windows 14 may independently adjust window opacity using individual controls. Alternatively, however, one or more of the dimmable windows 14, or all of the dimmable windows 14 may be controlled by a central controller 12 on-board the aircraft, operated by a pilot or cabin attendant. Accordingly, a pilot or cabin attendant may override opacity settings selected by passengers so as to fully dim or lighten the windows 14, for example and without limitation, in order to prepare the aircraft for landing or takeoff and for the overall comfort of passengers as where the cabin needs to be dimmed to allow passengers to sleep or view a movie. As will be discussed later in more detail, the central controller 12 operates the dimmable windows 14 through a wireless data link, thus obviating the need for wiring to connect the windows 14 to the central controller 12.

FIG. 2 depicts an alternate control system 10a in which a single energy harvester 18a is coupled with controllers 16 in order to control multiple windows 14.

Another embodiment of the control system 10b is shown in FIG. 3 wherein multiple energy harvesters 18a generate electrical power that is stored in a single energy storage device 22a. In this embodiment, multiple dimmable windows derive power from a single energy storage device 22a which may comprise a battery or capacitor, for example.

In still other embodiments, one of the controllers 16 may be used to control more than one of the dimmable windows 14.

Referring now simultaneously to FIGS. 1, 4 and 5, each of the controllers 16 comprises a control circuit broadly including a first power conditioning circuit 20, an energy storage device 22, a second power conditioning circuit 24, a processor 28, a radio transceiver 26 and a pair of passenger-operated push button control switches 30a, 30b.

The central controller 12 includes a wireless transceiver 15 that communicates with the radio transceiver 26 forming part of each of the controller 16, however, as will be describer later in more detail, the transceiver 15 may also function as a signal repeater that communicates with the transceivers 15 associated with other windows 14. The power conditioning circuit 20 receives energy from the energy harvester 18 and functions to condition this energy and trickle charge the energy storing device 22. A similar power conditioning circuit 24 maybe used to condition power used by the window 14, such as to provide power at specific voltages used to control the opacity of window 14. The processor 28 controls the flow of electrical power from the storage device 22 to the window 14 using a switching transistor 32. The energy storage device 22 may comprise a rechargeable battery or a super capacitor which receives conditioned power from the power conditioning circuit 20.

The processor 28 is powered using electrical power stored in the energy storage 22, and operates in any of four modes described below. The processor 28 may comprise a programmed microcontroller such as a Parallax BS2pe or a Texas instruments MSP430. The processor 28 may be programmed to maintain itself in a low power, “sleep” mode most of the time so as to draw minimal power from the storage device 22.

The processor 28 is programmed to periodically awaken from the sleep mode to check for broadcast radio communications signal from the central controller 12. When awakened, the processor 28 temporarily powers up the radio transceiver 26 to listen for signals from the transmitter 15. If such messages are present from the central controller 12, the processor 28 responds by carrying out the instructions contained in the transmitted message. These instructions may include, by way of example and without limitation, setting the window 14 to minimum opacity, setting the window 14 to maximum opacity, changing the passenger control set points or switching into a power down mode. After these instructions have been carried out, the processor 28 returns to the sleep mode.

The processor 28 may be programmed to awaken from the sleep mode on a periodic basis, for example every two seconds. In this case, each broadcast command from the central controller 12 would be broadcast continuously for at least two seconds in order to assure every window 14 will be awakened at least once during the duration of the broadcast from the central controller 12 and therefore have a chance to receive the command. In some embodiments, the control circuit 16 may require several milliseconds to check for broadcast messages from the central controller 12. It may thus be appreciated that each control circuit 16 remains in a low power sleep mode the majority of the time, and is awakened only to listen for possible commands from the central controller 12, or respond directly to a passenger request to change the opacity setting of the window 14.

It should be noted here that because the processors 28 in all of the windows 14 awaken and respond to broadcast commands from central controller 12 at different times (up to two seconds apart in the illustrated example), the processors 28 may commence their operations at slightly different times. Because these actions may take several seconds to complete (e.g. transition from minimum to maximum opacity, for example), the delay in certain windows may not be normally noticeable to passengers, and particularly since each window 14 may be transitioning from different opacity points which will tend to camouflage the time disparities between the windows 14.

Each of the processors 28 may also adjust a setting in its memory in response to broadcasted commands from the central controller 12 that require the processor 28 to respond in different ways to later inputs at control buttons used by passengers to change opacity settings. For example, if the central controller 12 sends a signal to the control circuits 16 to indicate that the passenger cabin is switching into a nighttime mode to facilitate movie watching or sleeping, a “minimum allowable opacity set point” variable in the memory of the processor 28 may be adjusted which later restricts the passenger's control of the window to a range of, for example, 95-100% of opacity. This function may be used, for example, to restrict the range of operation of the window 14 to 95-100% opacity (instead of 0-100% opacity) when the cabin crew wishes to configure the cabin to accommodate passenger sleeping or movie watching, while still allowing some degree of visibility through the windows 14.

The processor 28 also operates in a passenger control mode, in which the processor 28 is programmed to awaken anytime a passenger presses one of the passenger control buttons 30a, 30b used to change the opacity of window 14. When awakened, the processor 28 begins changing the opacity of window 14 in the direction corresponding to which of the buttons 30a, 30b has been pressed, until the passenger releases the button or until the window 14 has reached a predefined opacity set point, or maximum or minimum opacity levels. For example, a passenger may press a darken button (e.g. 30b) twice in order to darken the window 14 two set points darker. In this example, the processor 28 may flash an LED 34 (or 74 in FIG. 8) adjacent to a symbol on the control interface in order to indicate the target set point while the processor 28 operates to darken the window 14 to that selected set point.

Finally, the processor 28 may operate in a power down mode. In response to a command signal from the central controller 12, the processor 28 transitions into a semi-permanent, low power sleep mode or, alternatively may completely shut down. This mode may be entered, for example, when passenger control of the windows 14 is not necessary or desired. This mode may be used between flights, for example, anytime the aircraft is powered down, during aircraft overnight storage and/or during aircraft long term storage. In this mode, very little or no power is drawn from the energy storage device 22, if the storage device 22 continues to be trickle charged by any available energy from the energy harvesting device 18.

The power down mode of the processor 28 may be ended, for example, by pressing both passenger control buttons 30a, 30b simultaneously. The processor 28 may then power up the radio transceiver 26 in order to check for broadcast commands from the central controller 12. If a broadcast command is received by the radio transceiver 26, the processor 28 switches into the airplane control mode and carries out operations consistent with the command from central controller 12. If no such broadcast command is present from central controller 12, then the processor 28 may re-enter the sleep mode. It may thus be appreciated that the power down mode for the processor 28 allows the control system to draw no or minimal power when the dimming function for the window 14 is not needed.

Additional techniques may be used to further reduce the power consumption of the windows 14 and associated controller 16. For example, the processor 28 may be programmed to apply a short circuit across the window 14 in order to drive it toward 0 V in lieu of driving the window 14 to or through 0 V by applying an energy-consuming charge to the window 14. Also, energy recovery may be employed as the window 14 is driven toward 0 V, by programming the processor 28 to temporarily connect the window 14 to the input side of the first power conditioning circuit 20.

As shown in FIG. 8, the passenger control buttons 30a, 30b may be located adjacent the window 14, and may comprise momentary membrane push buttons, for example and without limitation, in which one of the buttons (30a) functions to lighten the window 14, while the other button 30b functions to darken the window 14. Indicator lights 74 may be optionally provided to provide a continuous or momentary indication of the opacity of the window 14 or the target opacity set-point toward which the window 14 is moving. The passenger selection buttons 30a, 30b allows the passenger to control window capacity in a continuous range or incremental steps.

Referring particularly now to FIG. 5 the processor 28 is powered by five volts derived from the storage device 22 and applied to the PWR pin on processor 28. As indicated above, the processor 28 typically draws little or no current from the storage device 22 while in the sleep mode and even less or no power during the power down mode. When the processor 28 periodically awakes, it delivers a signal on pin 8 which turns on the switching transistor 38, thereby coupling power to the radio transceiver 26, and allowing the control circuit 16 to “listen” for commands from the central controller 12.

Switches 30a, 30b, which are double pole, single throw switches (FIG. 5), are connected to pins 1 and 2, respectively of processor 28 and, as previously indicated function as passenger controls to control the opacity of window 14. Momentary closure of either switch 30a or 30b awakens the processor 28 to commence the passenger control mode. The push buttons 30a, 30b may have “up” and “down” or “lighten” and “darken” symbols printed on or near them using photoluminescent materials to allow viewing in a darkened cabin. When either button 30a or 30b is pressed, the processor begins the process of lightening or darkening the window 14. When the button 30a, 30b are released, the processor 28 terminates the process of lightening or darkening the window 14 and switches back into a sleep mode. Alternatively, pressing one of the buttons 30a, 30b may command the processor 28 to change the window 14 in preprogrammed opacity increments.

The remaining poles of switches 30a, 30b are connected to the reset pin of processor 28 and may be used to awaken the processor 28 from the power down mode. If desired, LEDs 34 may be used to illuminate membrane type switch buttons 30a, 30b when these buttons are pressed, or to visually indicate which preprogrammed set points to which the processor 28 is changing the window. This provides the passenger with visual feedback that his/her input has been received and is being processed. This feedback is especially useful for electrochromatic dimming windows that may respond slowly to changes in passenger settings.

The processor 28 includes memory that allows “learning” the opacity state of the window by any of several methods. For example, the processor 28 may measure the electric charge on the window 14, thereby inferring the opacity of the window 14. Alternatively, as shown in FIG. 7, an illuminated diode 68 and a phototransistor 70 may be positioned on opposite sides of the window 14, and cooperate as an opacity sensor. The sensed opacity may be input to the processor 28 in order to determine and record the current window opacity.

Additional details of portions of the controller 16 are shown in FIG. 6. The energy harvesting device 18 is connected to the control circuit 16 by a connector 40. Power from the harvesting device 18 is delivered to the power conditioning circuit 20 which may comprise a buck-boost converter that increases the voltage to a desired working level, for example 2.5V-3.3V in one useful embodiment. The converter may comprise a linear voltage regulator 44 coupled with a synchronous step-up converter 46. The conditioned power is delivered through a selector switch 62 to a connector 64 that is connected with the energy storage device 22 which may comprise a nickel metal hydride battery. Power output by the conditioning circuit 20 is also delivered to a step-up converter 48 which increases the voltage of the power output by the power conditioning circuit 20 to a voltage, such as 5 volts that is suitable to power the processor 28 as well as the radio 26 when the output from the energy storage device 22 is too low to maintain this required level of voltage.

The second power conditioning circuit 24 may comprise a voltage limiter which is controlled by the processor 28 and functions to limit the voltage applied to the window 14 to a pre-selected level, for example 1.2V in one useful embodiment. A connector 50 couples the processor 28 with the previously discussed radio transceiver 26 (FIG. 5). Transistor 32 is connected between the voltage limiter 24 and the window 14, and functions to limit the current applied to the window 14 based on programmed values stored in the processor 28.

The selector switch 62 is an optional item that can be used to switch delivery of the conditioned power from the harvester device 18 to any of multiple batteries or other energy storage devices.

Various other embodiments and variations are possible. For example, other methods may be employed to end the power down mode of the processor 28. The power down mode may be ended, for example, by pressing both passenger control buttons 30a, 30b which grounds the reset pin of the processor 28. Alternatively, a magnet 37 may be held close to a reed switch 36 (FIG. 5) which grounds a pin on the processor 28. In response to either of these pins being grounded, the processor 28 will then awaken and transition into the aircraft control mode or the sleep mode. This method is advantageous in that the radio transceiver 26 is not required to be powered up and the central controller 12 does not need to broadcast during the time it takes for personnel to awaken all the windows 14 at each window location.

In another embodiment, the central controller 12 may request each of the windows 14 to perform a self-check and report back the results. This self check, which is performed by each of the processors 28, may include, for example, a complete or summarized usage history and the current state of the energy storage device 22 (e.g. current voltage level). The processor 28 may then direct the transceiver 26 to transmit this status report to the central controller 12. The central controller 12 may individually address each of the windows 14 by communicating with the associated processors 28. Each of the windows 14 may report its particular location to the central controller 12 using any of several known methods, such as that disclosed in U.S. Pat. No. 7,137,594 issued Nov. 21, 2006, owned by The Boeing Company. To assist in addressing specific windows 14, each of the controllers 16 may include a programmable device that identifies the location of the associated window 14 within a cabin. For example, the controller 16 may include a simple DIP switch (dual in-line package switches) that may be set to uniquely identify the location of the window 14. By knowing the location of the windows 14, the central controller 12 can interrogate or control specific windows 14 or groups of windows. For example, the central controller 12 may issue commands dimming all of the windows only in the first class section of the aircraft.

It should be noted here that although the illustrated central controller 12 and controller 16 each include a transceiver 15, 26 to allow full duplex communication, in some applications only simplex or one-way communication may be needed. Where only one way communication is needed, transceivers are not required. Instead, the central controller 12 may have a radio transmitter (not shown) and the controller 16 may have a radio receiver (not shown). As will be discussed below, the transceiver 15 may also function as a signal repeater that retransmits the controls signals issued by the central controller 12, thereby extending the range of the central controller 12.

Another embodiment of the power down mode comprises lengthening the time by which the processor 28 is in the sleep mode, for example to a period of 10 minutes. In this embodiment, in order to end the power down mode, the central controller 12 would continuously transmit an “awake” message for at least 10 minutes. This method would reduce the average power consumption of the control system significantly.

Instead of lighten and darken passenger control buttons 30a, 30b shown in FIG. 8, two or more buttons 30c shown in FIG. 7 may be provided, wherein each of the buttons 30c corresponds to a specific opacity level. For example, the four push buttons 30c shown in FIG. 7 may, for example, correspond to 0%, 50%, 95% and 100% opacity levels for the window 14. In this embodiment, a passenger may for example, press the 50% button 30c. In this event, the processor 28 would then control the dimmable window 14 to a 50% opacity level. The advantage of this method is that the passenger only has to press the button momentarily and does not have to hold the button down until the desired opacity level is achieved. This embodiment is especially useful in connection with dimmable windows 14 that change slowly in opacity. Various other forms of passenger interface controls are possible, including toggling the target set point up or down on a scale of several predefined set points.

The central controller 12 may also send other commands to the window's controller 16. For example, the processor 28 may be commanded to change the color of the window 14 or to reveal an image in the window 14. The processor 28 may also be commanded to change the window 14 in a variety of other ways. For example, the processor 28 may be commanded to change the opacity of the window 14 vertically or horizontally, producing in effect, an opacity gradient over the window area, for example top-to-bottom or bottom-to-top. Similarly, the processor 28 might be commanded to change the opacity of a window 14 such that it has a fore-and-aft gradient, for example, being darker at the window's leading edge, gradually becoming more transparent moving aft across the window, or vice versa. The processor 28 may also be programmed to restrict the frequency of passenger interaction. For example, if the processor 28 detects that the passenger is activating the window 14 excessively, the processor 28 may initiate a “time out” mode wherein it will cease responding to all passenger commands for a set period of time, or may adjust the window opacity more slowly. The processor 28 may also monitor the voltage in the energy storage device 22 and initiate “time out” modes or slower opacity changes or initiate other energy saving modes, such as only responding to commands from the central controller 12.

Various photoluminescent materials may be applied or incorporated into the passenger control buttons 30a, 30b, 30c which respond to non-visible light sources. These non-visible light sources, such as ultraviolet light, may be included in the cabin interior lighting of the aircraft such that, even when cabin lights are turned down, this non-visible light source is present to illuminate the photoluminescent markings on the passenger control buttons 30a, 30b, 30c, thus making them visible in a darkened cabin.

Attention is now directed to FIGS. 9, 10 and 11 which depict details of one embodiment of a wireless network allowing central control of the dimmable windows 14, using a wireless network 89. FIG. 11 illustrates details of a window control circuit 16 (also later referred to as a window controller) that may be used in the network architectures shown in FIGS. 9 and 10, as well as in the networks shown in later discussed FIGS. 12, 13 and 14. The control circuit 16 includes a transceiver 26 that may receive control signals from either the central controller 78, a node transceiver 80 or another window circuit 16. Additionally, the transceiver 26 may retransmit the control signals to either the node transceiver 80 or another control circuit 16.

A central controller 78 may be located at any convenient or useful location on-board an aircraft 76. As previously indicated, the central controller 78 may include a wireless transceiver 15 as well as any other suitable controls and displays that might be used by a flight attendant, pilot or maintenance personnel to control the dimmable windows 14. The type and power output of the transceiver 15 may vary with the application, however generally, the transceiver 15 may have a power rating selected which to reduce the possibility of radio frequency interference with on-board electronics or off-board, airport systems when the aircraft 76 is on the ground. Accordingly, the transceiver 15 may not, in some cases, have a transmission range that is sufficient to extend throughout the entire cabin 76a of the aircraft 76; in this case, the transceivers 26 forming part of the window control circuits 16 may be out of communication range of the central controller 78.

In accordance with the disclosed embodiment, the communication network 89 utilizes one or more communication nodes 80a, 80b and 80c which may be spaced from the central controller 78, and from each other. In the illustrated example, nodes 80a-80c may be longitudinally spaced along the length of the cabin 76a, as best seen in FIG. 9. Each of the nodes 80a-80c may include a node transceiver 81a-81c that operates on a frequency allowing the transceiver 81-81c to receive window control signals from the central controller 78, and retransmit these signals to transceivers 26 at the windows within the transmission range of the node transceivers 81a-81c. Each of the nodes 80a-80c may have a range sufficient to retransmit the window control signals to an associated group 84, 86, 88 of window controllers (i.e. control circuits 16). Thus, node transceiver 81a may retransmit window control signals to window controllers 84a, 84b. Similarly, node transceiver 81b may retransmit window control signals to window controllers 86a, 86b which are slightly more distant from the central controller 78, and node transceiver 81c may retransmit the window control signals to window controllers 88a, 88b which are still further from the central controller 78.

The central controller 78 may also transmit window control signals directly to window controllers that are within its transmission range, such as window controllers 82 and 82a. In some applications, a window controller such as window controller 82a shown in FIG. 9, may lie along the edge of the transmission range of either the central controller 78 or the node transceiver 81a. In this case, the window controller 82a may receive window control signals from either the central controller 78 or the node transceiver 81a.

Where one of the window controllers 82, 84, 86, 88 may receive window control signals from multiple sources i.e. more than one node transceiver 81a-81c or the central controller 78, any of several known techniques may be used to avoid confusion due to the receipt of multiple control signals. For example, the window controllers 82-88 may impose a minimum time interval during which it will accept only one set of control signals. This time interval may be greater than the time required to propagate a set of control signals from the central controller 78 through the nodes 80a-80c, but shorter than the probable time interval between transmission of control signals from the central controller 78 for differing windows. Alternatively, each set of the control signals transmitted by the central controller 78 may possess a unique or rolling code that may be recognized by either the node transceivers 81a-81c and/or the window controllers 82-88. For example, encoded control signals received by node transceiver 81a may be interpreted as destined to be received by one of the window controllers 82a, 84a, 84b, in which case these control signals are not retransmitted to the node transceiver 81b.

Attention is now directed to FIGS. 12a-12c and FIG. 13 which illustrate an alternate form of communication network 95 that relies solely on the transceivers 26 (which form part of the control circuits 16) at each window 14 to extend the range of the central controller 78. The central controller 78 may be provided with a transceiver 15 having a transmission range that is limited to the circle designated at 90 in FIG. 12a. Thus, central controller 78 has a transmission range sufficient to communicate with window transceivers A and B but not window transceivers C, D, E and F.

In accordance with this embodiment, each of the window transceivers A-F may act as a repeater to retransmit control signals when received either from the central controller 78 or from another window transceiver A-F. Further, each of the window transceivers A-F retransmits the control signals it receives to any other window transceiver within its transmission range. As shown in FIG. 12b, the transmission range of the window transceivers A and B is shown by the circle 92. Thus, window transceivers C, D and E may receive control signals retransmitted by window transceivers A and B, however, window transceiver F is outside the range of either the central controller 78 or window transceivers A and B. Window transceiver F, is, however within the transmission range 94 of window transceivers C, D and E as shown in FIG. 12c.

FIG. 13 better illustrates some of the potential transmission paths that are possible in order to assure that control signals propagate from the central controller 78 down through the cabin so that all window transceivers A-F receive coverage. Thus for example, window transceiver B may retransmit control signals to window transceivers C, D or E. Similarly, window transceiver E may receive the same control signals retransmitted by window transceivers B, C and D.

When acting as a repeater, the order in which a control circuit 16 responds to received control signals may vary with the application, but in one embodiment, the control circuit 16, and particularly the transceiver 26 retransmits the control signals before executing the commands issued by the central controller 78. Thus, the control circuit 16 may allow the transceiver 26 to retransmit control signals to the surrounding window transceivers A-F, and then proceed to execute the command, such as commanding the window 14 to its maximum opacity. Random or sequential time lags may be programmed into the window transceivers A-F or the control signals 78 in order to assure that the transmitted signals propagate in an orderly manner from transceiver to transceiver without conflict.

FIG. 14 illustrates another embodiment in which control signals transmitted by the central controller are propagated either directly to a window controller 82 within range of the central controller 78, or are propagated throughout the aircraft cabin using a combination of node transceivers 80 and the window-to-window repeater technique used in the embodiment shown in FIGS. 12 and 13. Thus, in the illustrated example, window controllers 84 situated outside the transmission range of the central controller 78 are served by the node transceiver 80. Window controllers 96b, 96f which are outside of the transmission range of the node receiver 80 are served by a window controller 96a that is within range of the node transceiver 80. Similarly, window controllers 96d, 96e are outside the transmission range of the window controller 96a, however they are within range of window controller 96c.

Although the embodiments of this disclosure have been described with respect to certain exemplary embodiments, it is to be understood that the specific embodiments are for purposes of illustration and not limitation, as other variations will occur to those of skill in the art. For example, although the dimmable window system has been disclosed in connection with its application to aircraft, the system may be employed in other types of vehicles and in stationary applications such as in buildings.

What is claimed is:

1. A system for controlling windows on-board an aircraft, comprising:
a central controller, including a wireless transmitter for transmitting window control signals;
at least a first wireless repeater on-board the aircraft for receiving and retransmitting the window control signals; and,
at least a first group of window controllers respectively associated with and proximal to a first group of the windows for controlling the operation of the associated windows, each of the controllers in the first group including a wireless receiver for receiving the retransmitted window control signals.

2. The system of claim 1, further comprising a second group of window controllers respectively associated with and proximal to a second group of the windows for controlling the operation of the associated windows, each of the controllers in the second group of controllers including a wireless receiver for receiving the window control signals transmitted by the central controller.

3. The system of claim 2, wherein at least one of the window controllers in the second group of controllers may receive window control signals from the central controller.

4. The system of claim 1, further comprising at least a second wireless repeater for receiving window control signals from the first wireless repeater and for retransmitting the received control signals

5. The system of claim 1, further comprising a third group of window controllers respectively associated with and proximal to a third group of the windows for controlling the operation of the associated windows, each of the controllers in the third group of controllers including a wireless receiver for receiving the window control signals transmitted by the second wireless repeater.

6. The system of claim 2, wherein at least certain of the window controllers in the second group of controllers includes a wireless transmitter for retransmitting window control signals transmitted by the first wireless repeater.

7. The system of claim 1, wherein at least certain of the controllers in the first group thereof include a control circuit coupled with the associated window for controlling the opacity of the window.

8. The system of claim 1, further comprising a group of electrical power storage devices respectively associated with and proximal to the first group of the windows for supplying electrical power to the associated window controllers.

9. The system of claim 8, further comprising a group of energy harvesting devices respectively coupled with the power storage devices for harvesting energy and converting the harvested energy to electrical power.

10. A system for controlling a plurality of spatially distributed devices on-board an aircraft, comprising:
a central controller, including a wireless transmitter for transmitting device control signals; and,
a plurality of local controllers respectively associated with and proximal to the plurality of devices for controlling the operation of the devices, each of the local controllers including a wireless receiver for receiving device control signals, and wherein at least one of the local controllers includes a wireless transmitter for retransmitting control signals received from the central controller.

11. The system of claim 10, further comprising at least one wireless repeater on-board the aircraft for receiving and retransmitting the received device control signals.

12. The system of claim 10, wherein each of the local controllers includes a wireless transmitter for retransmitting device control signals received from the central controller or from one of the local controllers.

13. The system of claim 10, wherein the devices are dimmable windows, and each of the local controllers includes a control circuit coupled with a window for controlling the opacity of the window.

14. The system of claim 13, further comprising a plurality of electrical power storage devices respectively associated with and proximal to the windows for supplying electrical power to the associated local controller.

15. The system of claim 14, further comprising a plurality of energy harvesting devices coupled with the power storage devices for harvesting energy and converting the harvested energy to electrical power.

16. A method for centralized control of spatially distributed devices located on-board a vehicle, comprising the steps of:
(A) wirelessly transmitting device control signals from a central control location on-board the vehicle;
(B) receiving the device control signals transmitted in step (A) at a first node on-board the vehicle;
(C) wirelessly retransmitting the device control signals from the first node; and,
(D) receiving device control signals at a device location either transmitted in step (A) or retransmitted in step (C).

17. The method of claim 16, further comprising the steps of:
(E) receiving the device control signals retransmitted in step (C) at a second node; and,
(F) wirelessly retransmitting the device control signals from the second node.

18. The method of claim 16, further comprising the steps of:
(E) receiving the device control signals transmitted in step (A) at each of a first group of device locations; and
(F) receiving the device control signals retransmitted in step (C) at a second group of device locations.

19. The method of claim 16, further comprising the steps of:
(E) receiving the device control signals retransmitted instep (C) at a first device location; and,
(F) retransmitting the device control signal from the first device location to a second device location.

20. The method of claim 19, wherein steps (E) and (F) are performed using a wireless transceiver.

21. The method of claim 16, wherein step (B) and (C) are performed using wireless transceiver.

22. The method of claim 16, including the step of:
(E) generating data uniquely identifying the device location intended to receive a device control signal: and,
(F) incorporating the unique data in the device control signals transmitted in step (A).

23. A method of controlling electrically operated windows on an aircraft from a central location on-board the aircraft, comprising the steps of:
(A) transmitting wireless window control signals from the central location to a repeater on-board the aircraft;
(B) receiving the window control signals at the repeater;
(C) retransmitting the window control signals received in step (C);
(D) receiving the window control signals retransmitted in step (C) at a first window location; and,
(E) controlling a window at the first window location using the control signals received in step (D)

24. The method of claim 23, further comprising the steps of:
(F) receiving the window control signals transmitted in step (A) at a second window location; and,
(G) controlling a window at the second window location using the window control signal received in step (F).

25. The method of claim 23, wherein steps (E) and (G) each include changing the opacity of the window.

26. The method of claim 25, further comprising the steps of:
(H) harvesting energy on-board the aircraft;
(I) storing the energy harvested in step (H) as electrical power; and,
(J) using the electrical power stored in step (I) to control the opacity of the window.

27. The method of claim 23, further comprising the step of:
(F) encoding the window control signals with information identifying the intended window destination of each of the signals.

28. The method of claim 23, wherein step (E) includes changing the opacity of the window.

29. The method of claim 23, wherein step (E) includes producing an opacity gradient across the window.

30. The method of claim 23, wherein step (E) includes displaying an image in the window.

31. The method of claim 23, wherein step (E) includes displaying a color in the window.
